(19) United States
(12) Patent Application Publication
(10) Pub. No.: US 2017/0036611 A1
(43) Pub. Date: Feb. 9, 2017

(54) GROCERY BAG RESTRAINT APPARATUS FOR VEHICLES

(71) Applicant: Michael Archie Underwood, Debary, FL (US)

(72) Inventor: Michael Archie Underwood, Debary, FL (US)

(21) Appl. No.: 15/003,990

(22) Filed: Jan. 22, 2016

Related U.S. Application Data
(60) Provisional application No. 62/200,680, filed on Aug. 4, 2015.

(51) Int. Cl. B60R 7/08

(52) U.S. Cl. CPC B60R 7/08

(57) ABSTRACT

A grocery bag restraint apparatus is provided. The grocery bag restraint apparatus includes a horizontal strap having a first end and a second end. The first end of is securable to a first side of a trunk of a vehicle and the second end is securable to a second side of the trunk. A plurality of mounting straps may be attached to and hang from different portions of the horizontal strap. Each of the mountings straps include a first end attached to the horizontal strap and a second end releasably attached to the first end of the mounting strap or the horizontal strap, forming a loop which secures to a handle portion of a grocery bag.

### CROSS-REFERENCE TO RELATED APPLICATION

This application claims the benefit of priority of U.S. provisional application No. 62/200,680, filed Aug. 4, 2015, the contents of which are herein incorporated by reference.

### BACKGROUND OF THE INVENTION

The present invention relates to transporting grocery bags and, more particularly, to a securement strap for securing grocery bags in a trunk.

When placing grocery bags in a trunk or cargo space, the contents of the grocery bags may come out while driving the vehicle. Currently, to prevent this from happening, cargo nets are used. However, cargo nets tend to squish and thereby damage the food like a loaf of bread or produce, as a cargo net compresses these items tightly.

As can be seen, there is a need for an improved system of securing grocery bags within a trunk or cargo space.

### SUMMARY OF THE INVENTION

In one aspect of the present invention, a grocery bag restraint apparatus comprises: a horizontal strap comprising a first end configured to secure to a first side of a trunk of a vehicle and a second end configured to secure to a second side opposite the first side of the trunk; and a plurality of mounting straps each comprising a first end attached to a different portion of the horizontal strap, wherein the plurality of mounting straps hang from the horizontal strap; wherein each of the plurality of mounting straps comprises a second end releasably attached to at least one of the first end of the mounting strap and the horizontal strap, forming a loop.

In another aspect of the present invention, a method of restraining grocery bags in a vehicle comprises: providing a horizontal strap comprising at least one mounting strap hanging therefrom; securing a first end of the horizontal strap to a first side of a trunk of a vehicle; securing a second end of the horizontal strap to a second side of the trunk of the vehicle; looping the mounting strap through a handle portion of a grocery bag; and releasably attaching a first end of the mounting strap to at least one of a second end of the mounting strap and the horizontal strap.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention installed in an exemplary vehicle;

FIG. 2 is a perspective view of an embodiment of the present invention in use in an exemplary vehicle;

FIG. 3 is an elevation view of an embodiment of the present invention;

FIG. 4 is a cross-sectional view taken along line 4-4 in FIG. 1; and

FIG. 5 is a cross-sectional view taken along line 5-5 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a grocery bag restraint apparatus to secure and restrain grocery bags upright during transit. The present invention secures and restrains the contents better than a cargo net since the present invention does not squish items, like a loaf of bread or produce. Further, the present invention prevents the contents from spilling out and rolling around in the trunk of vehicle.

The grocery bag restraint apparatus may include an elongated horizontal strap with a plurality of mounting straps secured along the length of the elongated horizontal strap. The elongated horizontal strap may be easily removed from the trunk and the mounting straps may be easily removed and placed in different positions along the horizontal strap. Further, the present invention secures and restrains the paper or plastic grocery bags in an upright position during transit, not allowing the bags to bunch up together and slide from side-to-side hitting against the vehicle interior.

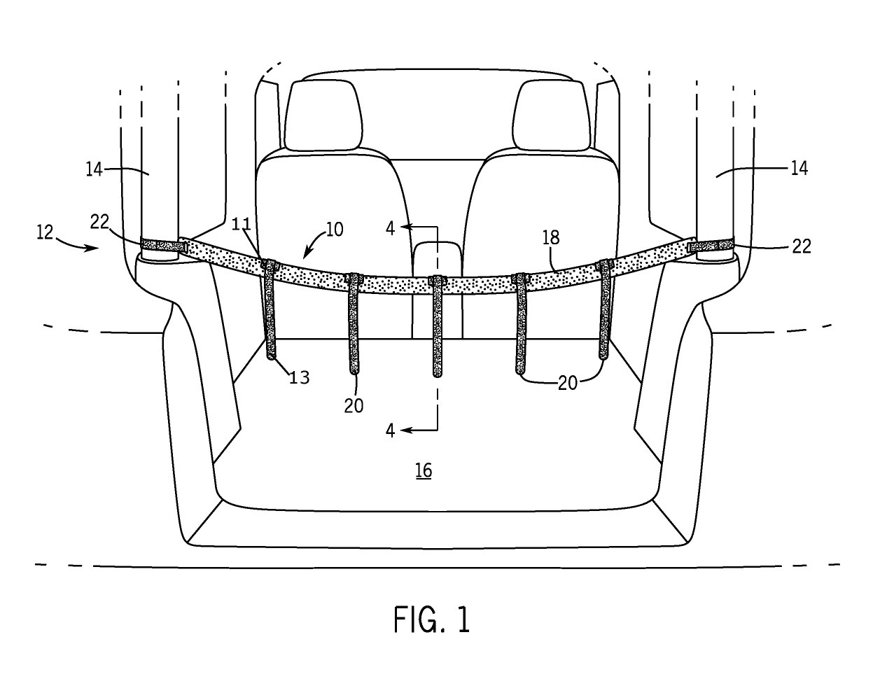

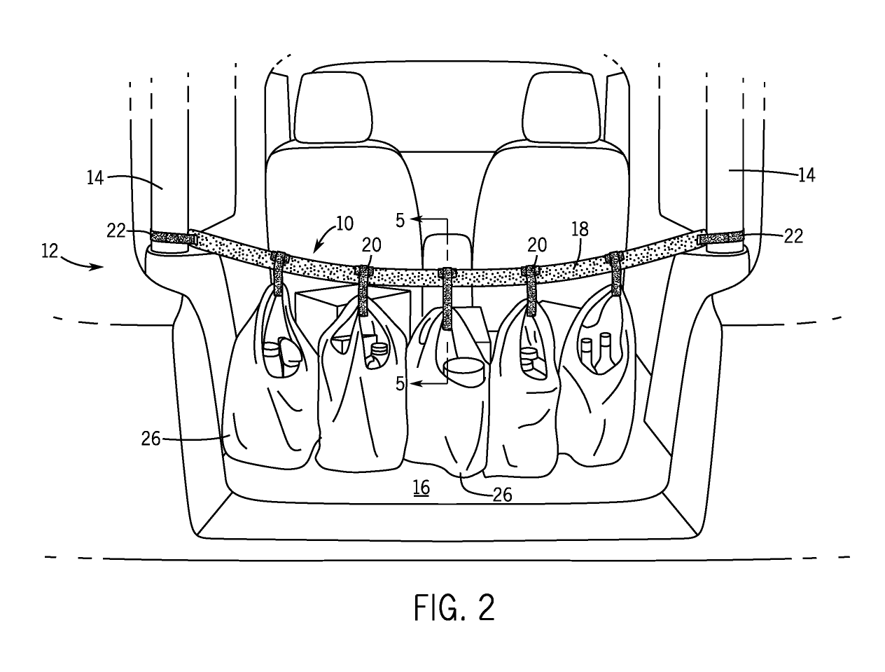

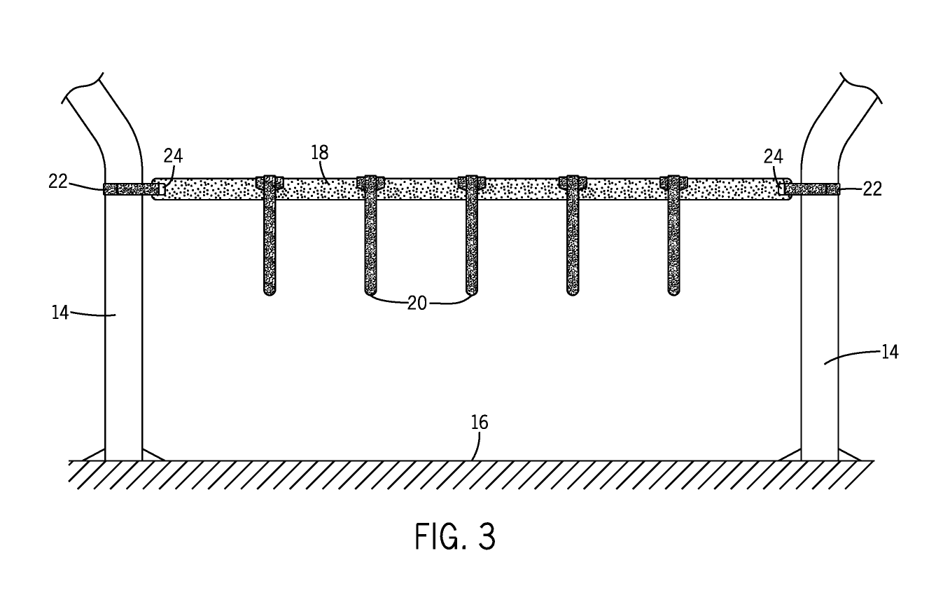

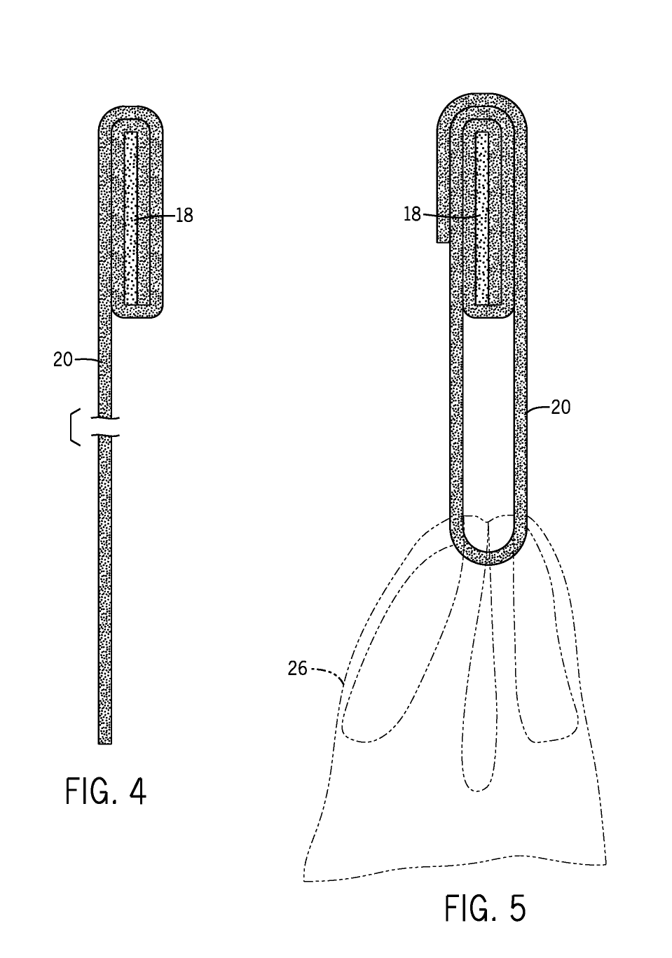

Referring to FIGS. 1 through 5, the present invention includes a grocery bag restraint apparatus 10. The grocery bag restraint apparatus 10 includes a horizontal strap 18 having a first end and a second end. The first end of is securable to a first side of a trunk 16 of a vehicle 12 and the second end is securable to a second side of the trunk 16. A plurality of mounting straps 20 may be attached to and hang from different portions of the horizontal strap 18. Each of the mountings straps 20 include a first end attached to the horizontal strap 18 and a second end releasably attached to the horizontal strap 18 or the first end of the mounting strap 20, forming a loop which secures to a handle portion of a grocery bag 26 within.

In certain embodiment, the first end of each of the mounting straps 20 may include a first connector 11 and a second end of each of the mounting straps 20 may include a second connector 13. The first connector 11 is releasably attachable to the second connector 13 forming the loop. In certain embodiments, the first connector 11 and the second connector 13 may be a hook and loop fastener.

In certain embodiments, the horizontal strap 18 may include a loop fastener and the mounting straps 20 may include a hook fastener. In such embodiments, the mounting straps 20 may be wrapped around the horizontal strap 18, thereby connecting the hook and loop together. The mounting strap 20 may loop around the handle of the grocery gab 26 and hook fastener may either attach to a loop portion formed on the first end of the mounting strap 20 or the loop portion on the horizontal strap 18.

The first end and the second end of the horizontal strap 18 may be secured to roll bars 14 within the trunk 16. In such embodiments, a first side strap 22 may be disposed through a first opening 24 formed through the first end of the horizontal strap 18 and a second side strap 22 may be disposed through a second opening 24 formed through the second end of the horizontal strap 28. Each of the first side strap 22 and the second side strap 22 are sized to fit around the roll bar 14 of the trunk 16 of the vehicle 12. In certain embodiments, the horizontal straps 28 may include first and second connectors 11, 13 similar to that of the mounting straps 20. In certain embodiments, the first and second connectors 11, 13 may be hook and loop fasteners. Therefore, the side straps 22 are looped around the roll bar 14 and the hook fastener secures to the loop fastener.

A method of restraining grocery bags 26 within a trunk 16 of a vehicle 12 may include the following. The first side strap 22 is inserted through the opening 24 of the first end of the horizontal strap 18 and wrapped around a first roll bar 14 of the trunk 16 of the vehicle 12. A first end of the first side strap 22 is then secured to a second end of first side strap 22 by a hook and loop fastener. The second side strap 22 is inserted through the opening 24 of the second end of the horizontal strap 18 and wrapped around a second roll bar 14 of the trunk 16 of the vehicle 12. A first end of the second side strap 22 is then secured to a second end of the second side strap 22 by a hook and loop fastener. At least one mounting strap 20, such as a plurality of mounting straps 20, are attached to the horizontal strap 18. The mounting straps 20 are then looped through the handle portions of the grocery bag 26. The second end of the mounting straps 20 are then attached to at least one of the horizontal strap 18 and the first end of the mounting strap 20. The grocery bag 26 is supported by the mounting strap 20 in an upright position.

It should be understood, of course, that the foregoing relates to exemplary embodiments of the invention and that modifications may be made without departing from the spirit and scope of the invention as set forth in the following claims.

What is claimed is:

1. A grocery bag restraint apparatus comprising:
a horizontal strap comprising a first end configured to secure to a first side of a trunk of a vehicle and a second end configured to secure to a second side opposite the first side of the trunk; and
a plurality of mounting straps each comprising a first end attached to a different portion of the horizontal strap, wherein the plurality of mounting straps hang from the horizontal strap; wherein
each of the plurality of mounting straps comprises a second end releasably attached to at least one of the first end of the mounting strap and the horizontal strap, forming a loop.

2. The grocery bag restraint apparatus of claim 1, wherein the first end of each of the plurality of mounting straps comprises a first connector and a second end of each of the plurality of mounting straps comprises a second connector releasably attached to the first connector.

3. The grocery bag restraint apparatus of claim 2, wherein the first connector and the second connector comprise a hook and loop fastener.

4. The grocery bag restraint apparatus of claim 1, further comprising a first side strap disposed through a first opening formed through the first end of the horizontal strap and a second side strap disposed through a second opening formed through the second end of the horizontal strap, wherein each of the first side strap and the second side strap are sized to fit around a roll bar of the trunk of the vehicle.

5. The grocery bag restraint apparatus of claim 4, wherein each of the first side strap and the second side strap comprise a hook and loop fastener.

6. A method of restraining grocery bags in a vehicle comprising:
providing a horizontal strap comprising at least one mounting strap hanging therefrom;
securing a first end of the horizontal strap to a first side of a trunk of a vehicle;
securing a second end of the horizontal strap to a second side of the trunk of the vehicle;
looping the mounting strap through a handle portion of a grocery bag; and
releasably attaching a first end of the mounting strap to at least one of a second end of the mounting strap and the horizontal strap.

7. The method of claim 6, wherein the first side of the trunk comprises a first roll bar and the second side of the trunk comprises a second roll bar.

8. The method of claim 6, wherein the first end of each of the plurality of mounting straps comprises a first connector and a second end of each of the plurality of mounting straps comprises a second connector releasably attached to the first connector.

9. The method of claim 8, wherein the first connector and the second connector comprise a hook and loop fastener.

10. The method of claim 6, wherein the at least one mounting strap comprises a plurality of mounting straps.
